(19) United States
(12) Patent Application Publication
(10) Pub. No.: US 2021/0394551 A1
(43) Pub. Date: Dec. 23, 2021

(54) PROCESS AND APPARATUS FOR DECORATING MANUFACTURED ARTICLES BY MEANS OF THERMOSETTING POWDER PAINT

(71) Applicant: S.E.F. ITALIA S.R.L., Carate Brianza (MB) (IT)

(72) Inventors: Giovanni BORTOLATO, Carate Brianza (MB) (IT); Gilberto MENIN, Como (IT)

(73) Assignee: S.E.F. ITALIA S.R.L., Carate Brianza (MB) (IT)

(21) Appl. No.: 17/284,068

(22) PCT Filed: Oct. 8, 2019
(86) PCT No.: PCT/IB2019/058542

§ 371 Date: Apr. 9, 2021

(30) Foreign Application Priority Data
Oct. 12, 2018 (IT) 102018000009403

(51) Int. Cl. B44C 3/02; B05C 19/00; B05C 13/00; B41M 1/22; B41M 1/28; B41F 9/06; B41F 23/08; B41F 23/00

(52) U.S. Cl. CPC B44C 3/02; B05C 19/00; B05C 13/00; B41F 23/007; B41M 1/28; B41F 9/06; B41F 23/08; B41M 1/22

(57) ABSTRACT

An apparatus decorates manufactured articles via thermosetting powder paint. The apparatus contains a decoration station with a plane, a decoration unit having a rotating cylinder supported by a carriage movable along the longitudinal extension of the manufactured articles, and a system for applying the paint to the cylinder and transferring the paint onto the manufactured articles. The outer surface of the cylinder has engraved cavities, which represent the pattern to be reproduced on the manufactured articles and are designed to contain the paint. The system has a reservoir to contain the paint, which contacts the outer surface of the cylinder and is introduced into the cavities. The reservoir has a bottom with a free end placed close to the outer engraved surface of the cylinder to identify a point for the fall of the paint from the cavities to the manufactured articles during the rotation of the cylinder.

The present invention relates to an apparatus for decorating metallic or non-metallic manufactured articles, resistant to high temperatures, by means of thermosetting powder paints. In particular, but not exclusively, such manufactured articles can be aluminium profiles.

The invention also relates to a process for decorating manufactured articles by means of such apparatus.

In the field of metal profiles, some manufactured articles are only painted (or treated superficially with appropriate electrochemical processes adapted to guarantee adequate protection against corrosion, besides giving the desired aesthetic appearance). Whereas, other manufactured articles are also subjected to a process for decorating the previously treated surfaces: for example, decorating metal profiles with a “wood effect” surface finishing, typically for producing doors and windows, is very requested.

These two operations (painting, or another basic treatment, and successively decorating the surfaces thus treated) are generally carried out in two successive steps, in two different plants: in a first step, the surface of the manufactured article undergoes a basic treatment, which, as said, can include applying a base paint by means of thermosetting powders, or an electrochemical treatment, for example, by means of anodizing; in a second step, the desired decoration is applied onto the surface of the thus pre-treated manufactured article.

As regards the decoration step, the most commonly used techniques nowadays can substantially be grouped into two types.

One first technology consists in the decoration by means of sublimation, where the metal profiles are painted with thermosetting powder paints adapted for sublimation and subjected to polymerization of the powders.

Successively, after polymerization, the profiles pass to the sublimation plant, where they are covered with special inked films bearing the desired pattern to be reproduced. The film, kept in contact with the surface of the profile, is heated at a temperature (usually between 180° C. and 210° C.) at which the inks sublime, thus transferring the pattern from the film inside the layer of powder paint, which was applied previously, onto the surface of the profile.

This system is capable of generating high quality patterns, but it entails high costs because the process requires considerable labour and costly raw materials. The second technology being considered is the so-called “powder on powder” decoration. Based on this technique, the profiles are painted with thermosetting powder paints, as in the previous case, however, the powder is not subjected to complete polymerization: in fact, the oven is kept at a lower temperature (about 120° C.) in order to obtain only a partial polymerization of the base powder.

Then, the profiles, positioned on a special pallet, are transferred below the decoration machine, usually mounted onto a movable carriage.

Various techniques can be used to carry out the decoration.

A flat screen template can be used, for example, made up of a frame with a perforated mesh according to the pattern to be created. According to the principles of screen printing, a squeegee is made to slide along the frame so as to cause the powder paint to pass through the perforated mesh, so that it is deposited onto the surface of the underlying profile. However, this system requires significant manual intervention.

Another process adopted to carry out the decoration on the surface of the profile requires the use of a continuous belt, bearing the pattern to be reproduced engraved on the surface thereof. The engraving cavities are filled, in a loading station, with the powder paint. In the lower part of the plant, close to the profile to be decorated, the belt is made to turn about a roller with a small diameter, which causes the opening of the engraving cavities, making the powder fall, by gravity, onto the underlying profile. However, this system does not allow well-defined patterns to be obtained and any change in the pattern to be reproduced would mean having to replace the whole belt.

Furthermore, special powders must be used, characterised by high smoothness and by a specific granulometry, compatible with the size of the cavities, to allow an effective retention of the powder during the movement of the belt and a correct release thereof at the falling point onto the profile.

A further process used to carry out the decoration on the surface of the profile is the one described, for example, in the International application WO 2007/009489, which uses a screen template formed by a rotating cylinder, made of a metal sheet perforated according to the pattern to be reproduced, which is made to advance along the profile. The cylinder is supplied internally with the thermosetting powder paint and a squeegee positioned inside the cylinder forces the powder, during the rotation of the cylinder (and corresponding advancing along the profile), to pass through the holes of the perforated wall thereof, falling onto the surface of the profile. Also in this case, a change in pattern requires replacing the whole perforated roller and the powder must have an elevated smoothness and specific granulometry in order to be able to pass through the holes of the cylindrical template without blocking them. Furthermore, maintaining and cleaning the internal part of the roller can be difficult and, in general, the perforated mesh, necessarily with a reduced thickness, can easily be subject to wear and damage.

It is a general object of the present invention to overcome the previously stated drawbacks by providing an apparatus for decorating manufactured articles by means of thermosetting powders, which allows the creation of decorations with elevated quality and pattern definition, requiring minimum labour and low energy consumption, with a consequent overall reduction in costs.

It is a further object of the present invention to allow the quantity of powder supplied to be easily regulated and modified, for example, to adapt to specific features of the pattern to be reproduced or to the chemical-physical features of the powders themselves.

It is a further object of the present invention to allow the pattern to be reproduced, as well as the powder used, to be changed easily.

It is a further object of the present invention to enable the use of a same formulation of the powder paint, both for the base painting and for the decoration.

In view of such object, it was decided to develop an apparatus, according to the invention, for decorating manufactured articles, according to a set pattern, by means of thermosetting powder paint, comprising a decoration station provided with a plane intended to support at least one manufactured article to be decorated, to which said at least one manufactured article to be decorated is conveyed, hooked at its ends to conveyors, and with a decoration unit equipped with at least one rotating decoration cylinder, arranged at a higher level with respect to said at least one manufactured article present on the plane, and with a system for applying the powder paint to the decoration cylinder and for transferring the same onto an exposed surface of the manufactured article, said rotating cylinder having an axis perpendicular to the longitudinal extension of the manufactured article to be decorated and being supported by a carriage movable along the longitudinal extension of the manufactured article so as to horizontally translate the cylinder, during its rotation, advancing above the exposed surface of the manufactured article to be decorated, characterized in that engraved cavities are present on the outer surface of the rotating cylinder, representing the pattern to be reproduced on the surface of the manufactured article and which are designed to be filled with the powder paint to be transferred onto the manufactured article, and in that the system for applying and transferring the powder paint comprises a reservoir suitable to contain a quantity of powder paint brought into contact with the outer surface of the cylinder to be introduced and temporarily kept in its cavities, said reservoir being delimited below by a bottom, fixed to the carriage and provided with a free end placed close to the outer engraved surface of the cylinder to identify a falling point for the progressive fall of the powder paint from the cavities to the exposed surface of the manufactured article during the rotation of the cylinder, according to the set pattern to be reproduced.

According to the invention, a process was further developed for decorating manufactured articles according to a set pattern, by means of thermosetting powder paint, using such decoration apparatus, comprising the steps of:
bringing one or more manufactured articles to be decorated in correspondence with the decoration station, hooked at their ends to conveyors;
positioning said one or more manufactured articles on a support plane in said decoration station, under a decoration unit equipped with at least one rotating decoration cylinder bearing, on its outer surface, a plurality of engraved cavities, reproducing the set pattern to be transferred onto the surface of the manufactured articles, said cylinder being supported by a carriage movable along the longitudinal extension of said one or more manufactured articles so as to horizontally translate the cylinder, during its rotation, advancing above the exposed surface of said one or more manufactured articles to be decorated;
providing a thermosetting powder paint to a reservoir arranged in the decoration unit and delimited below by a bottom, fixed to the carriage and provided with a free end placed close to said outer surface of the decoration cylinder;
moving the carriage forward along the longitudinal extension of said one or more manufactured articles to be decorated, starting from a first end thereof, while the decoration cylinder is rotated, during the rotation the outer surface of the decoration cylinder coming into contact with the powder paint contained in the reservoir so that the powder paint penetrates into said cavities and so that the bottom of the powder paint reservoir, through its free end, exerts a pressure against the outer surface of the cylinder adapted to maintain the paint grains inside said cavities until, following the rotation of the cylinder, the cavities containing the powder paint reach and pass said free end, coming out of the cavities and falling, by gravity, onto the exposed surface of said one or more manufactured articles, according to the set pattern to be reproduced;
after the carriage has reached the opposite end of said one or more manufactured articles to be decorated, withdrawing the carriage, bringing it back to the starting point in correspondence of the first end of said one or more manufactured articles, during the retraction of the carriage a device for the generation and application of an electrostatic charge to the powder paint deposited on said one or more manufactured articles being activated;
sending said one or more manufactured articles to an oven for the polymerization of the thermosetting powder paint applied on their surface.

To clarify the explanation of the innovative principles of the present invention and the advantages thereof with respect to the prior art, one possible illustrative embodiment applying such principles will be described below, with the aid of the attached drawings. In the drawings:

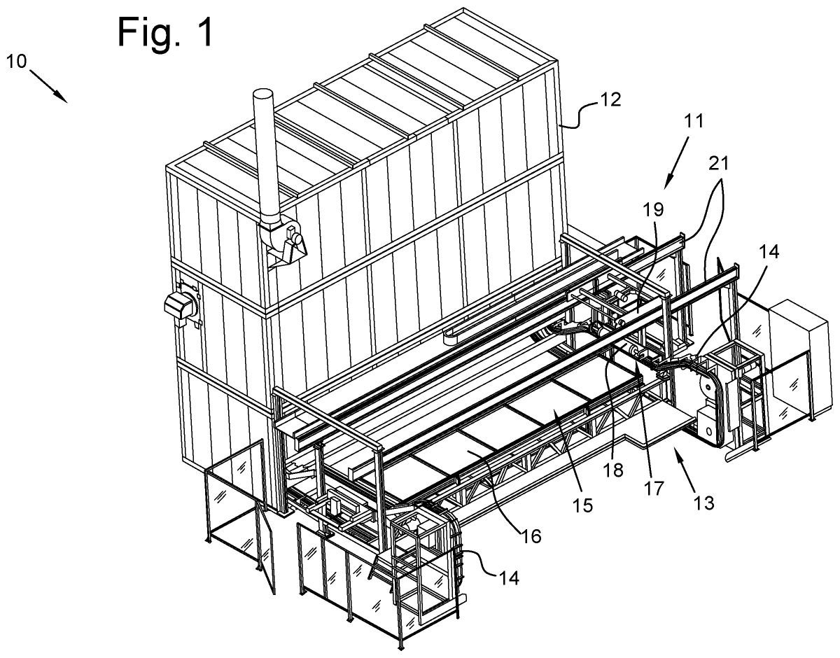

FIG. 1 represents a general view of a system for decorating manufactured articles by means of thermosetting powder paints according to the present invention;

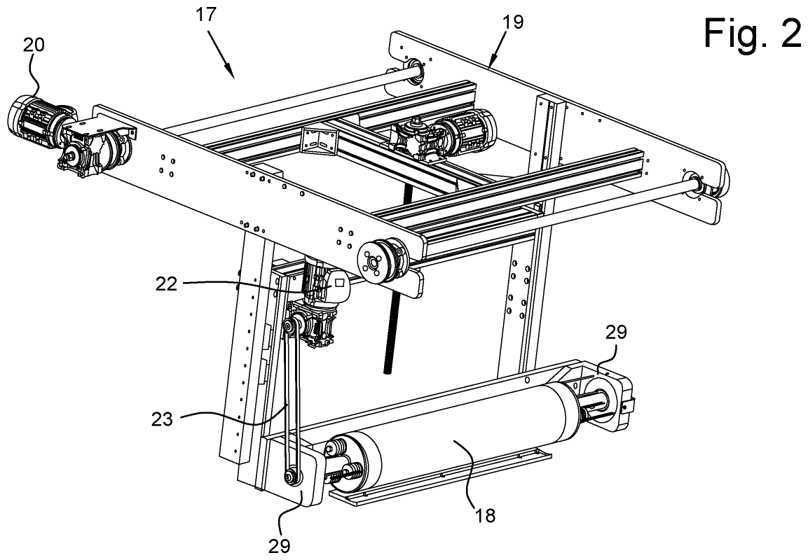

FIG. 2 represents an overall view of the rotating cylinder for decorating manufactured articles, mounted on the movable carriage for the advancement thereof along the manufactured article;

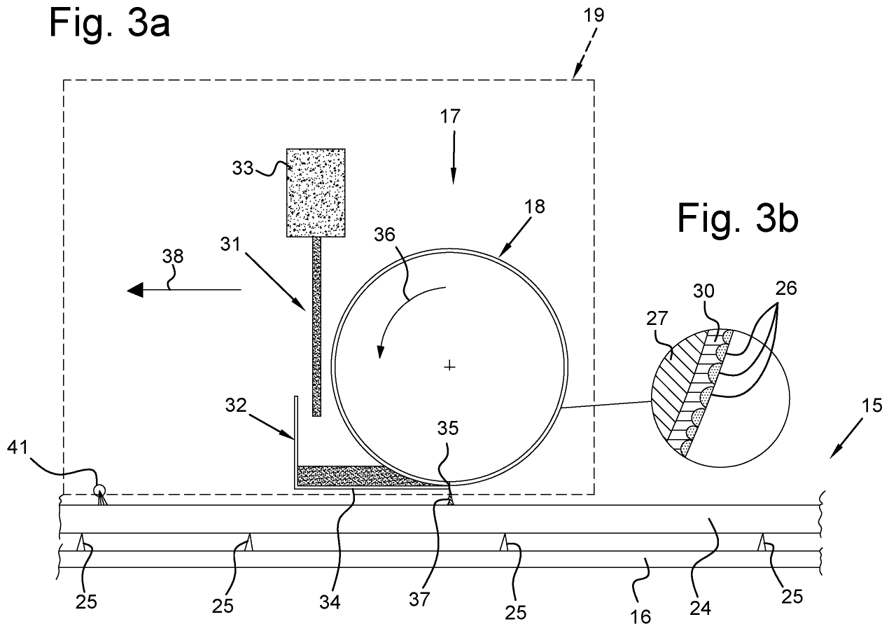

FIG. 3a represents a schematic side view of the decoration unit with the rotating cylinder in the operational position for decorating the manufactured article;

FIG. 3b schematically represents an enlarged detail of the surface portion of the decoration cylinder;

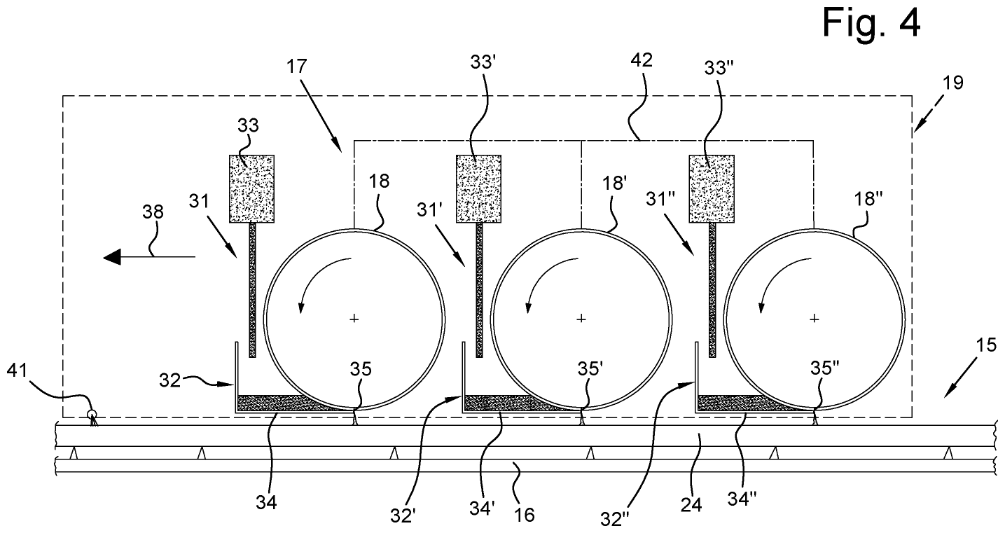

FIG. 4 schematically shows a side view of a possible variation of the decoration unit, similar to the one of FIG. 3a;

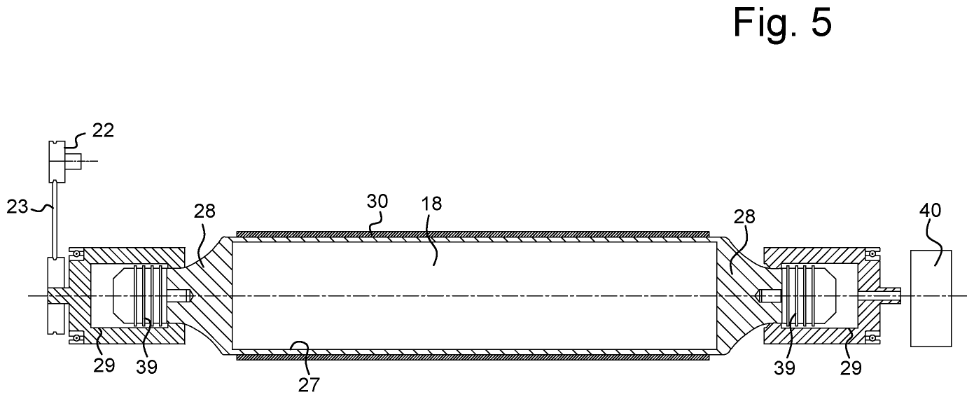

FIG. 5 represents a longitudinal sectional view of the decoration cylinder;

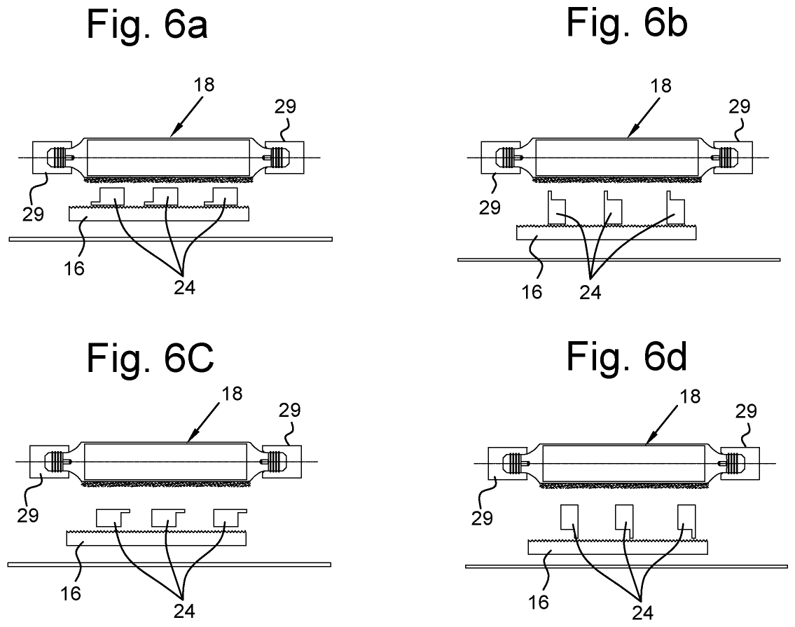

FIGS. 6a-6d schematically represent successive decoration steps of the various faces of the manufactured article by the rotating cylinder.

The present invention specifically relates to the surface decoration of manufactured articles (for example, metal profiles), the surface of which has previously been subjected to a basic treatment, which can typically consist of applying a base paint by means of thermosetting powders or of an electrochemical treatment, for example, by means of anodizing.

With reference to the figures, a plant 10 for painting and decorating manufactured articles comprises, in particular, an apparatus 11 for decorating manufactured articles by means of thermosetting powder paints and an oven 12 for the polymerization of the decoration and the possible base painting of the manufactured article if the aforesaid surface pre-treatment consists of a base painting also by means of thermosetting powders.

In particular, the apparatus 11 comprises a loading zone 13 where the manufactured articles coming from a pre-treatment station (not shown in the figures), wherein the surfaces thereof have been subjected to the aforesaid basic pre-treatment by means of painting with thermosetting powders or by means of electrochemical treatment or another suitable basic treatment, are hooked at the ends thereof, manually or automatically, to conveyors 14 (advantageously a pair of continuous conveyors arranged at the respective ends of the metal profiles) adapted to be operated advancing step-by step.

If the manufactured articles, in the pre-treatment station, have been subjected to basic painting with thermosetting powders, the polymerization of the base paint in such station will only have been carried out partially (at temperatures comprised between 120° C. and 150° C.) in order to allow an effective application of the further thermosetting powders in the decoration apparatus 11, according to the concepts of the “powder on powder” technology.

The apparatus 11 further comprises a decoration station 15, arranged along the path of the aforesaid conveyors 14, wherein a vertically movable plane 16 is present, designed to support the profiles to be decorated, and a decoration unit 17 provided with a rotating decoration cylinder 18 having an axis perpendicular to the longitudinal extension of the profiles to be decorated. The rotating cylinder 18 is arranged at a higher level than the profiles present on the plane 16 and it is supported by a carriage 19 movable along the longitudinal extension of the profiles to horizontally translate the cylinder 18 during the rotation thereof advancing above the exposed face of the manufactured articles to be decorated.

The carriage 19 is adapted to slide, moved by a motor 20, along a pair of horizontal guides 21 arranged longitudinally above the support plane 16 of the manufactured articles.

The carriage 19 with the rotating cylinder 18 is shown in further detail in FIG. 2. In particular, a motor 22, with respective drive (advantageously belt drive) 23, is comprised for the rotation of the cylinder at the desired speed.

FIG. 3a schematically shows a side view of a longitudinal portion of the vertically movable plane 16 and of a profile 24 resting thereon by means of a plurality of support elements 25, with the decoration cylinder 18 above, along with the respective devices adapted for the transfer of the powder paint onto the surface of the manufactured article according to the set pattern.

Clearly, as an expert can easily imagine, the support elements 25 are realised in such a configuration as to keep the manufactured article stably in a horizontal position, at the desired distance below the cylinder 18, but without damaging or removing the powder paint previously applied (and not yet polymerized) on the respective face of the manufactured article, while the paint is being applied on the opposite face, facing the cylinder 18.

As it can be seen in the enlarged detail in FIG. 3b, engraved cavities 26 are present on the outer surface of the rotating cylinder 18, representing the pattern intended to be reproduced on the surface of the manufactured article and which are designed to be filled with the powder paint to be transferred to the manufactured article 24, as will be explained in further detail below.

FIG. 5 shows a longitudinal section of the decoration cylinder 18, comprising a body 27 rotatably supported, with the ends thereof 28, in respective seats 29 on the movable carriage 19.

The engraved cavities 26, designed to be filled with the powder paint to be transferred to the manufactured article 24 for reproducing the desired pattern, can be obtained directly on the outer surface of the body 27 of the cylinder 18 or, more advantageously, they can be present on the surface of a jacket 30 applied coaxially on the outside of the body 27 of the cylinder 18, as shown in detail in FIG. 3b.

Nonetheless, the set of cavities 26 advantageously extends in an axial direction along the cylinder 18 for an extension equal to at least the maximum size of the profiles on the support plane 16, in a transverse direction to the longitudinal extension of the same profiles, so as to allow the powder paint to be deposited on the exposed face of all of the profiles 24 possibly present on the plane with a single stroke of the carriage 19. Here, by exposed face (or exposed surface) of the profile we mean the surface of the manufactured article directly facing the decoration cylinder 18, thus designed to receive the powder paint contained in the engraved cavities 26 thereof.

The circumferential development of the cylinder 18 (specifically of the outer surface of the body 27 thereof or, in the case, of the outer jacket 30) instead determines the pitch of the pattern to be transferred to the exposed surface of the manufactured articles in a repetitive manner on every complete rotation of the cylinder.

The decoration unit 17 further comprises a system 31 for applying the powder paint to the decoration cylinder 18 and for the transfer thereof onto the exposed surface of the profile 24.

The application and transfer system 31 substantially comprises a reservoir 32, adapted to contain a quantity of powder paint designed to be introduced into the cavities 26 of the cylinder, and a device 33 for supplying the powder paint to the reservoir 32, made up, for example, of a hopper with a continuous or intermittent discharge, as an expert can easily imagine depending on the specific needs of operation.

The reservoir 32 is delimited below by a bottom 34, fixed to the carriage 19 and provided with a free end 35 placed close to the outer surface of the cylinder 18 engraved with the cavities 26.

During operation of the decoration apparatus, by rotating in the direction of the arrow 36 shown in FIG. 3a, the cylinder 18 brings the engraved surface thereof to be “immersed” in the reservoir 32, allowing the powder paint to penetrate the cavities 26, representing the pattern to be reproduced. In fact, said bottom 34, with the free end 35 thereof, constitutes a squeegee, which cooperates with the rotating cylinder 18 to optimise the load of powders in the cavities 26, pressing the powders against the surface of the cylinder and retaining them temporarily inside the cavities. Following the rotation of the cylinder in the direction of the arrow 36, as the cavities 26 go beyond the edge of the squeegee (free end of the bottom 34), the powders contained therein can gradually fall, by gravity, onto the exposed surface of the manufactured article 24 according to the set pattern to be reproduced.

The falling point 37 of the powders from the decoration cylinder 18 onto the surface of the profile moves along the longitudinal extension of the manufactured article due to the translation movement of the carriage 19 along the horizontal guides 21 in the direction of the arrow 38 shown in FIG. 3a. Advantageously, the advancement speed of the carriage 19 is synchronised with the rotation speed of the cylinder 18 so that the peripheral speed of the cylinder at the falling point of the powders onto the manufactured article is equal to, and opposite to, the speed of the carriage.

In the decoration apparatus according to the invention it was found to be particularly advantageous to provide the rotating cylinder 18 with vibrating supports, adapted to vibrate the cylinder during the operational step (i.e. during the loading of the powder paint into the cavities 26 and the discharging thereof onto the surface of the profile).

To this end, as it can be seen in FIG. 5, the ends 28 of the rotating cylinder 18, at the seats 29 on the movable carriage 19, are provided with ultrasonic piezoelectric transducers 39, supplied by an appropriate rotating contact 40, to generate the vibration of the cylinder with respect to the carriage 19. In fact, due to the vibration induced in the cylinder 18, both the introduction of the powder paint into the cavities 26 at the reservoir 32 and the exit of the powders from said cavities and the detachment thereof from the cylinder at the falling point 37 onto the surface of the manufactured article to be decorated are facilitated.

The decoration unit 17 further comprises a device 41 for generating and applying an electrostatic charge to the powder paint deposited on the manufactured article, which is adapted to favour the temporary adhesion of the paint to the surface of the manufactured article according to the set pattern while waiting for the final polymerization in the oven. Advantageously, the device 41 for generating and applying the electrostatic charge is also fixed to the movable carriage 19.

Operatively, after positioning one or more profiles 24 on the support plane 16, hooked at the ends thereof to the conveyors 14 and resting on the support elements 25, the movable carriage 19 is made to advance, starting from a first end of the profiles, with the decoration cylinder 18 arranged there above, at a sufficiently small distance to guarantee the best possible definition in the reproduction of the pattern. At the same time, the decoration cylinder 18 is rotated, in synchronisation with the advancing of the carriage 19.

During the rotation, the outer engraved surface of the cylinder, or of the jacket 30 thereof, is immersed in the reservoir 32 of powder paint where, with the aid of the vibration induced by the ultrasonic piezoelectric transducers 39, the thermosetting powder penetrates the cavities 26, which reproduce the set pattern to be transferred onto the surface of the profiles.

The squeegee, made up of the bottom 34 of the powder reservoir 32, with the free end 35 thereof placed close to the outer surface of the cylinder, exerts a pressure against it, which contributes to keeping the grains of paint inside the aforesaid cavities 26.

Following the rotation of the cylinder, as the cavities go beyond the edge of the squeegee, reaching the falling point 37, the grains of paint exit therefrom (even in this case, due to the vibration induced by the ultrasonic piezoelectric transducers) and fall, by gravity, onto the exposed surface of the profiles 24 according to the set pattern to be reproduced.

After the carriage 19 has reached the point of maximum advancement, at the opposite end of the profiles, it is caused to withdraw and brought back to the starting point. During the return stroke, the device 41 is activated for generating and applying the electrostatic charge to the powder paint deposited on the profiles.

At this point, if only once face of the profile needs to be decorated, the manufactured article 24 can be sent, by means of the conveyors 14, to the oven 12 for the final polymerization of the thermosetting paint.

On the other hand, if the other faces also need to be decorated, the profiles are rotated by 90° (or by another angle, which might be necessary) about the longitudinal axis thereof to repeat the cycle described above on the new exposed face. To this end, advantageously, the hooking means of the ends of the profiles to the conveyors 14 can be configured, as an expert can easily imagine, to allow an automatic rotation of the manufactured articles, without any manual intervention of releasing and re-hooking. Any differences in size in the thickness of the manufactured articles depending on the angle of rotation according to which they are resting on the plane 16 can be compensated due to the vertical mobility of the plane itself, so as to keep the exposed face of the manufactured articles always at the desired optimum distance with respect to the decoration cylinder 18.

The cycle described above can thus be repeated until all of the faces of the profiles have been covered with the thermosetting powder paint according to the set pattern (see FIGS. 6a-6d). At this point, the profiles can finally be transferred to the oven 12 for the polymerization of the paint.

FIG. 4 schematically shows a possible variation of the decoration unit 17, wherein several rotating cylinders 18, 18′, 18″ are comprised, supported by the carriage and sequentially arranged along the advancement direction 38 of the carriage itself.

Advantageously, in this case, with each rotating cylinder 18, 18′, 18″, a system 31, 31′, 31″ thereof is associated for applying the powder paint to the respective decoration cylinder and for the transfer thereof onto the exposed surface of the profile 24. In particular, a respective hopper 33, 33′, 33″ is comprised for each cylinder 18, 18′, 18″ for supplying the powder paint, as well as a corresponding reservoir 32, 32′, 32″ adapted to contain a quantity of powder paint designed to be introduced into the surface cavities 26 of the respective cylinder. Each reservoir 32, 32′, 32″ is delimited below by a respective bottom 34, 34′, 34″ provided with a free end 35, 35′, 35″ placed close to the outer surface of the cylinder thereof.

Thanks to this solution, it is possible to transfer, onto the manufactured article, two or more patterns at the same time: in particular, different colours can be used for each cylinder to obtain, for example, an “antique” effect or to create a particularly elaborate decoration by overlapping several patterns with a relatively simple design, each transferred by a respective cylinder of the unit.

According to a preferred embodiment, all of the cylinders 18, 18′, 18″ are supported by the same carriage 19 and the respective rotation speeds thereof are connected, mechanically or electronically (as shown schematically in FIG. 4, by means of the connection line 42), as an expert can easily imagine, so as to synchronise the fall of the powder paint from each cylinder onto the surface of the manufactured article, fully respecting the pattern of the final decoration to be created.

Of course, the number of cylinders 18, 18′, 18″ can differ from what is shown in FIG. 4, according to the effective needs of the decoration process.

At this point, it is clear how the set objectives were able to be reached thanks to the present invention.

In fact, with respect to the prior art, wherein the powder paints were made to pass through a perforated wall, the use of a cylinder as described here, allows the engraving corresponding to the pattern to be reproduced, to be made in a precise manner, on the outer surface thereof (for example, by means of laser technology), thus obtaining a highly defined reproduction.

Furthermore, the vibration applied to the cylinder by means of the piezometric transducers greatly facilitates the introduction of the powders into the engraving cavities, with a complete filling thereof, and the successive exit therefrom, at the edge of the squeegee, also contributing therewith to obtaining an elevated definition of the reproduction of the pattern. Moreover, the use of ultrasonic piezometric transducers makes the energy consumption extremely low and allows a fine adjustment of the quantity of powder used.

A particularly high definition of the decoration can also be obtained, in the case of the embodiment with several rotating cylinders shown in FIG. 4, due to the option of applying two or more patterns on the manufactured article simultaneously, each having a relatively simple design, or different colour effects. By making the engraving of the pattern on the surface of an outer jacket applied to the body of the cylinder, the pattern to be reproduced can be changed easily and cheaply, simply by replacing the jacket with another one bearing the engraving of the new pattern.

Clearly, the above description of an embodiment applying the innovative principles of the present invention is given by way of an illustrative example of such innovative principles and must not, therefore, be taken to limit the scope of the patent claimed herein. For example, the supply of the powder paint to the reservoir 32 can be carried out by means of known pumping systems (airless, Venturi, etc.). A special sensor can be provided for detecting the level of powder in the reservoir 32 and consequently controlling the supply of the powder itself.

A suction system for the excess powder can be provided at the support plane 16 of the profiles, there below. The outer engraved surface of the cylinder 18 (i.e. the jacket 30 or the outer surface of the body 27) can be made of a suitable material (for example, steel, copper, rubber or also by means of a suitable anti-abrasive or anti-adhesive coating) adapted to house, retain and release the powder paint in a wide range of granulometries, in an optimum manner.

After the step of applying the decoration onto the profile, and before the polymerization of the powder paint in the oven, a coat of see-through powder paint can also be applied to the manufactured article, to protect the decoration.

1: An apparatus, comprising
a decoration station provided with a plane supporting at least one manufactured article to be decorated using thermosetting powder paint according to a set pattern, to which said at least one manufactured article is conveyed by hooking at its ends to conveyors, and with a decoration unit equipped with at least one rotating decoration cylinder, arranged at a higher level with respect to said at least one manufactured article present on the plane, and with at least one system for applying the thermosetting powder paint to the at least one rotating decoration cylinder and for transferring the same onto an exposed surface of the at least one manufactured article, said at least one rotating decoration cylinder having an axis perpendicular to a longitudinal extension of the at least one manufactured article and being supported by a carriage movable along the longitudinal extension of the at least one manufactured article so as to horizontally translate the at least one rotating decoration cylinder, during its rotation, advancing above the exposed surface of the at least one manufactured article,
wherein
engraved cavities are present on an outer surface of the at least one rotating decoration cylinder, representing the set pattern to be reproduced on the exposed surface of the at least one manufactured article,
the engraved cavities are designed to be filled with the thermosetting powder paint to be transferred onto the at least one manufactured article,
the at least one system for applying and transferring the thermosetting powder paint comprises a reservoir suitable to contain the thermosetting powder paint, which is brought into contact with the outer surface of the at least one rotating decoration cylinder and is introduced and temporarily kept in the engraved cavities, and
said reservoir is delimited below by a bottom, fixed to the carriage and provided with a free end placed close to the outer surface of the at least one rotating decoration cylinder to identify a falling point for a progressive fall of the thermosetting powder paint from the engraved cavities to the exposed surface of the at least one manufactured article during the rotation of the at least one rotating decoration cylinder, according to the set pattern to be reproduced.

2: The apparatus according to claim 1, wherein said engraved cavities are present on a surface of a jacket coaxially applied outside of the at least one rotating decoration cylinder.

3: The apparatus according to claim 1, wherein the carriage moves at an advancement translation speed synchronized with a rotation speed of the at least one rotating decoration cylinder so that a peripheral speed of the at least one rotating decoration cylinder at the falling point is equal to, and opposite to, the advancement translation speed of the carriage.

4: The apparatus according to claim 1, wherein the at least one rotating decoration cylinder is supported by the carriage via vibrating supports, which vibrate the at lease one rotating decoration cylinder at least during a process of charging the thermosetting powder paint into the engraved cavities and discharging the same onto the exposed surface of the at least one manufactured article.

5: The apparatus according to claim 4, wherein the at least one rotating decoration cylinder is provided with ends, which are rotatably housed within seats on the carriage and equipped with ultrasonic piezoelectric transducers to generate vibration of the at least one rotating decoration cylinder with respect to the carriage.

6: The apparatus according to claim 1, wherein the decoration unit further comprises, on said carriage, a device for generating and applying an electrostatic charge to the thermosetting powder paint deposited on the at least one manufactured article to facilitate adhesion of the thermosetting powder paint onto the exposed surface of the at least one manufactured article according to the set pattern.

7: The apparatus according to claim 1, wherein the ends of the at least one manufactured article is hooked to the conveyors through a pivotable hooking to allow rotation of said at least one manufactured article around its own longitudinal axis.

8: The apparatus according to claim 1, wherein the plane supporting the at least one manufactured article is vertically movable with respect to the at least one rotating decoration cylinder.

9: The apparatus according to claim 1, wherein the plane supporting the at least one manufactured article is provided with support elements for maintaining the at least one manufactured article stably in a horizontal position below the at least one rotating decoration cylinder.

10: The apparatus according to claim 1, wherein
the decoration unit comprises two or more rotating decoration cylinders supported by said carriage and sequentially arranged along an advancement direction of the carriage, and
with respective rotations of the two or more rotating decoration cylinders mechanically or electronically connected each other, a respective system for applying the thermosetting powder paint to the respective rotating decoration cylinder and for transferring the thermosetting powder paint onto the exposed surface of the at least one manufactured article is associated with each of said two or more rotating decoration cylinders.

11: A process for decorating at least one manufactured article using the apparatus according to claim 1, the process comprising:
a) bringing the at least one manufactured article to the decoration station and hooking ends of the at least one manufactured article to the conveyors;
b) positioning the at least one manufactured article on the plane and under the decoration unit equipped with the at least one rotating decoration cylinder;
c) providing the thermosetting powder paint to the reservoir arranged in the decoration unit;
d) moving the carriage forward along the longitudinal extension of said at least one manufactured article, starting from a first end thereof as a starting point, wherein the at least one rotating decoration cylinder is rotated, and during the rotation the outer surface of the at least one rotating decoration cylinder contacts the thermosetting powder paint contained in the reservoir so that the thermosetting powder paint penetrates into said engraved cavities and the bottom of the reservoir, through its free end, exerts a pressure against the outer surface of the at least one rotating decoration cylinder adapted to maintain the thermosetting powder paint inside said engraved cavities until, following the rotation of the at least one rotating decoration cylinder, the engraved cavities containing the thermosetting powder paint reach and pass said free end and the thermosetting powder paint comes out of the engraved cavities and falls by gravity onto the exposed surface of said at least one manufactured article according to the set pattern to be reproduced;
e) after the carriage reaches an opposite end of said at least one manufactured article, retracting the carriage to the starting point, and during the retraction of the carriage a device for generating and applying an electrostatic charge to the thermosetting powder paint deposited on said at least one manufactured article is activated; and
f) sending said at least one manufactured article to an oven for polymerizing the thermosetting powder paint.

12: The process according to claim 11, further comprising:
after the retraction of the carriage, rotating said at least one manufactured article around its longitudinal axis in correspondence of its ends hooked to the conveyors to expose a new surface to the at least one rotating decoration cylinder and to repeat d) and e) on the new exposed surface until the thermosetting powder paint is completely applied to said at least one manufactured article.

13: The process according to claim 11, wherein at least in d), the at least one rotating decoration cylinder is vibrated with respect to the carriage.

14: The process according to claim 13, wherein the vibration of the at least one rotating decoration cylinder with respect to the carriage is achieved by ultrasonic piezoelectric transducers placed in seats on the carriage that rotatably house ends of the at least one rotating decoration cylinder.

15: The process according to claim 11, further comprising:
prior to a), subjecting said at least one manufactured article to a basic pre-treatment of its surfaces to be decorated.

16: The process according to claim 15, wherein said pre-treatment consists of a base painting with a thermosetting powder paint, followed by a partial polymerisation of the paint at a temperature ranging between 120° C. and 150° C.
